(19) United States
(12) Patent Application Publication
(10) Pub. No.: US 2006/0199913 A1
(43) Pub. Date: Sep. 7, 2006

(54) Method for producing hyperbranched polymers

(76) Inventors: Jean-Francois Stumbe, Strasbourg (FR); Bernd Bruchmann, Freinsheim (DE); Joelle Bedat, Offendorf (FR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/563,971

(22) PCT Filed: Jun. 25, 2004
(86) PCT No.: PCT/EP04/06911

§ 371 Date: Jan. 6, 2006

(30) Foreign Application Priority Data
Jul. 11, 2003 (DE) 103 31 770.8

(51) Int. Cl. C08F 297/02

(52) U.S. Cl. 525/242

(57) ABSTRACT

A process for preparing hyperbranched polymers comprises reacting compounds of the formula I 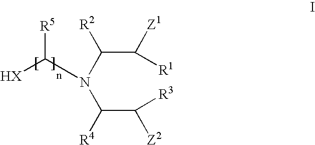 where X is sulfur or oxygen,
R¹ and R³ are identical or different and are hydrogen, C₁-C₆ alkyl, C₃-C₁₂ cycloalkyl or C₆-C₁₄ aryl,
R² and R⁴ are identical or different and are hydrogen, C₁-C₆ alkyl, C₃-C₁₂ cycloalkyl, C₆-C₁₄ aryl,
Z¹ and Z² are identical or different and are COOH or COOR⁶, the radicals R⁶ being identical or different and being C₁-C₆ alkyl, formyl or CO—C₁-C₆ alkyl,
R⁵ identically or differently at each occurrence is C₁-C₆ alkyl or hydrogen, and n is an integer from 2 to 10,
   optionally with at least one compound of the formula Ia 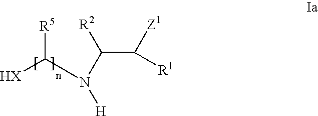 where the variables are as defined above, in the presence of a catalyst.

The present invention relates to a process for preparing hyperbranched polymers which comprises reacting compounds of the formula I 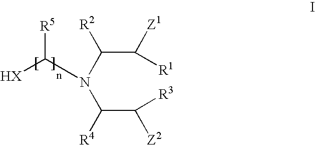
where
X is sulfur or oxygen,
R¹ and R³ are identical or different and are hydrogen, C₁-C₆ alkyl, C₃-C₁₂ cycloalkyl or C₆-C₁₄ aryl,
R² and R⁴ are identical or different and are hydrogen, C₁-C₆ alkyl, C₃-C₁₂ cycloalkyl, C₆-C₁₄ aryl,
Z¹ and Z² are identical or different and are COOH or COOR⁶, the radicals R⁶ being identical or different and being C₁-C₆ alkyl, formyl or CO—C₁-C₆ alkyl,
R⁵ identically or differently at each occurrence is C₁-C₆ alkyl or hydrogen, and
n is an integer from 2 to 10,
optionally with at least one compound of the formula Ia 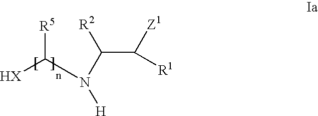
where the variables are as defined above,
in the presence of a catalyst.

Dendrimers, arborols, starburst polymers, and hyperbranched polymers are designations for polymeric structures which are distinguished by a branched structure and a high functionality. Dendrimers are macromolecules possessing molecular and structural uniformity and a highly symmetrical construction. They are synthesized in multistage syntheses, in the majority of cases necessitate the use of protecting group chemistry, and hence are expensive. U.S. Pat. No. 4,507,466 may be mentioned by way of example.

In contrast, hyperbranched polymers, as they are known, possess both molecular and structural nonuniformity. For a definition and an overview of hyperbranched polymers see, for example, Nachrichten aus Chemie, Technik und Laboratorium, 2002, 50, 1218 and also Dendrimers and Dendrons, Concepts, Syntheses, Applications by G. R. Newkome, C. N. Moorefield, F. Vögtle, Wiley-VCH, 2001. Particularly suitable for the synthesis of hyperbranched polymers are what are called ABₓ molecules. ABₓ molecules have two different functional groups, A and B, which are able to react with one another to form a linkage. The functional group A is present in the molecule only once, the group B at least twice, i.e., x is an integer greater than or equal to 2. The reaction of the ABₓ molecules with one another produces uncrosslinked hyperbranched polymers having regularly arranged branching sites. Hyperbranched polymers then almost exclusively have B end groups at the chain ends. Further details are disclosed in, for example, J.M.S.—Rev. Macromol. Chem. 1997, C37(3), 555.

From WO 02/36697 it is known that hyperbranched polymers having functional groups are useful as additives to liquid inks for, for example, flexographic printing.

Modified high-functionality hyperbranched polyesters and dendrimers based on polyester are known per se—see, for example, WO 96/19537—and are already being used in some applications, as an impact modifier, for example., Dendrimers, however, are too costly for general use, since the syntheses impose exacting requirements on yields of the constructional reactions and purity of the intermediates and end products and require reagents which are too expensive for large-scale industrial use. The preparation of hyperbranched high-functionality polyesters prepared by conventional esterification reactions normally requires fairly drastic conditions—cf. WO 96/19537—such as high temperatures and/or strong acids. As a result there can be secondary reactions such as, for example, dehydration reactions, decarboxylations, and, as a consequence of the secondary reactions, unwanted instances of resinification and discoloration.

At the Belgium Polymer Group Meeting, 2002, I. Mievis and Y. Geerts presented a poster on which they demonstrated the preparation of hyperbranched polyesters based on AB₂ monomers which were synthesized by Michael addition of N,N-diethanolamine onto methyl acrylate. No precise data on the polymer obtained were disclosed. Lu Yin et al. in Acta Polym. Sinica 2000, volume 4, p. 411 and volume 5, p. 554 disclose the synthesis of hyperbranched polyamine esters having an extremely broad molecular weight distribution (volume 4, page 412, Table 2, lines 1 and 2). In addition, Lu Yin et al. disclose polyamine esters having an extremely narrow molecular weight distribution (same table, lines 3-5), prepared by what is called a pseudo-one-stage process. The pseudo-one-stage process comprises reacting 1,1,1-trimethylolpropane, as a so-called core molecule, with two or more portions of N,N-diethylol-3-aminomethyl propionate. N,N-Diethylol-3-aminomethyl propionate is obtained from methacrylic acid and N,N-diethanolamine, reacted in a molar ratio of 1:1. H. Wei et al. disclose in J. Appl. Polym. Sci. 2003, 87, 168 that the dendrimers and hyperbranched polymers obtainable in this way can be photopolymerized following modification with acrylic end groups.

The properties of the hyperbranched polymers published by H. Wei et al., however, are inadequate for some technical applications. In particular, molecular weight and functionality of the hyperbranched polymers described are inadequate for many technical applications.

It is an object of the present invention to provide hyperbranched polymers having enhanced performance properties. It is a further object of the present invention to provide a process by which new hyperbranched polymers can be prepared.

We have found that these objects are achieved by the hyperbranched polymers defined at the outset.

The present invention accordingly provides a process for preparing the hyperbranched polymers of the invention, referred to below as the process of the invention.

In one embodiment of the present invention the process of the invention is performed starting from compounds of the formula I

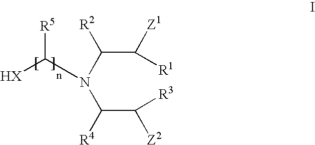

where

X is sulfur or, preferably, oxygen;

R¹ and R³ are different or, preferably, identical and are hydrogen,
C₁-C₆ alkyl such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl or sec-hexyl, more preferably C₁-C₄ alkyl such as methyl, ethyl, n-propyl, isopropyl, n-butyl, isobutyl, sec-butyl or tert-butyl;
C₃-C₁₂ cycloalkyl such as cyclopropyl, cyclobutyl, cyclopentyl, cyclohexyl, cycloheptyl, cyclooctyl, cyclononyl, cyclodecyl, cycloundecyl or cyclododecyl; preferably cyclopentyl, cyclohexyl or cycloheptyl;
C₆-C₁₄ aryl such as phenyl, 1-naphthyl, 2-naphthyl, 1-anthryl, 2-anthryl, 9-anthryl, 1-phenanthryl, 2-phenanthryl, 3-phenanthryl, 4-phenanthryl or 9-phenanthryl, preferably phenyl, 1-naphthyl or 2-naphthyl, more preferably phenyl.
With particular preference R¹ and R³ are each identical and are each hydrogen or methyl.

R² and R⁴ are different or, preferably, identical and are
hydrogen,
C₁-C₆ alkyl such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl or sec-hexyl, more preferably C₁-C₄ alkyl such as methyl, ethyl, n-propyl, isopropyl, n-butyl, isobutyl, sec-butyl or tert-butyl;
C₃-C₁₂ cycloalkyl such as cyclopropyl, cyclobutyl, cyclopentyl, cyclohexyl, cycloheptyl, cyclooctyl, cyclononyl, cyclodecyl, cycloundecyl or cyclododecyl, preferably cyclopentyl, cyclohexyl or cycloheptyl;
C₆-C₁₄ aryl such as phenyl, 1-naphthyl, 2-naphthyl, 1-anthryl, 2-anthryl, 9-anthryl, 1-phenanthryl, 2-phenanthryl, 3-phenanthryl, 4-phenanthryl or 9-phenanthryl, preferably phenyl, 1-naphthyl or 2-naphthyl, more preferably phenyl.
With particular preference R² and R⁴ are each hydrogen.

Z¹ and Z² are different or, preferably, identical and are COOH or, preferably, COOR⁶, the radicals R⁶ being different or, preferably, identical and being
C₁-C₆ alkyl such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl or sec-hexyl, more preferably C₁-C₄ alkyl such as methyl, ethyl, n-propyl, isopropyl, n-butyl, isobutyl, sec-butyl or tert-butyl;
formyl,
CO—C₁-C₆ alkyl such as, for example, CO—CH₃ (acetyl), n-propionyl, isopropionyl, n-butyryl, sec-butyryl, pivaloyl, n-valeroyl or n-caproyl.

R⁵ is identical or different, preferably identical, at each occurrence and is
C₁-C₆ alkyl such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl or sec-hexyl, more preferably C₁-C₄ alkyl such as methyl, ethyl, n-propyl, isopropyl, n-butyl, isobutyl, sec-butyl or tert-butyl;
or in particular hydrogen.

n is an integer from 2 to 10, preferably up to 4, and more preferably up to 3.

Compound of the formula I is reacted by addition of catalyst.

The process of the invention can be performed in the presence of a compound Ia

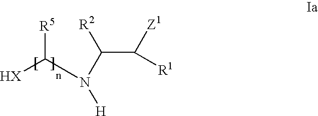

in which the variables are as defined above. Where the process of the invention is performed in the presence of compounds I and Ia it is preferred for the variables to correspond to one another; i.e., R¹ from compound I and compound Ia are each identical, R² from compound I and compound Ia are each identical, and so on.

It is possible to use from 0 to 1 000% by weight of compound Ia, based on compound I, preferably from 0 to 100% by weight, more preferably from 10 to 50% by weight.

The process of the invention can be conducted in the presence or absence of at least one polyfunctional compound, which is able to act as a core molecule. Polyfunctional compounds for the purposes of the present invention are compounds having two or more identical or different functional groups, such as acids or their derivatives, such as esters, acid halides or anhydrides, for example.

Examples that may be mentioned include the following:

dicarboxylic acids, such as oxalic acid, malonic acid, succinic acid, glutaric acid, adipic acid, pimelic acid, sebacic acid, azelaic acid, phthalic acid, isophthalic acid, terephthalic acid, and also monoesters and diesters, especially mono- and di-C₁-C₄ alkyl esters, halides and anhydrides of the aforementioned dicarboxylic acids, C₁-C₄ alkyl being selected from methyl, ethyl, n-propyl, isopropyl, n-butyl, isobutyl, sec-butyl, and tert-butyl;

tricarboxylic acids, such as trimellitic acid (1,2,4-benzenetricarboxylic acid), 1,3,5-benzenetricarboxylic acid, and also monoesters, diesters, and triesters, especially mono-, di- and tri-C₁-C₄ alkyl esters, halides and anhydrides of the aforementioned tricarboxylic acids, C₁-C₄ alkyl being selected from methyl, ethyl, n-propyl, isopropyl, n-butyl, isobutyl, sec-butyl, and tert-butyl;

tetracarboxylic acids, such as ethylenediaminetetraacetic acid (EDTA), pyromellitic acid (benzene-1,2,4,5-tetracarboxylic acid), and monoesters, diesters, and triesters, especially mono-, di-, tri-, and tetra-C₁-C₄ alkyl esters, halides and anhydrides of the aforementioned tetracarboxylic acids, C₁-C₄ alkyl being selected from methyl, ethyl, n-propyl, isopropyl, n-butyl, isobutyl, sec-butyl, and tert-butyl. It will be appreciated that mixtures of said di-, tri-,.and tetracarboxylic acids or derivatives thereof can also be employed.

In addition, for example, diisocyanates or polyisocyanates can also be used as core molecules. Suitable diisocyanates and polyisocyanates are the aliphatic, cycloaliphatic, and aromatic isocyanates known from the prior art. Preferred diisocyanates or polyisocyanates are diphenylmethane 4,4′-diisocyanate, the mixtures of monomeric diphenylmethane diisocyanates and oligomeric diphenylmethane diisocyanates (polymeric MDI), tetramethylene diisocyanate, tetramethylene diisocyanate trimers, hexamethylene diisocyanate, hexamethylene diisocyanate trimers, isophorone diisocyanate trimer, 4,4′-methylenebis(cyclohexyl) diisocyanate, xylylene diisocyanate, tetramethylxylylene diisocyanate, dodecyl diisocyanate, lysine alkyl ester diisocyanate, in which alkyl is C₁ to C₁₀, 2,2,4- or 2,4,4-trimethyl-1,6-hexamethylene diisocyanate, 1,4-diisocyanatocyclohexane or 4-isocyanatomethyl-1,8-octamethylene diisocyanate, 2,4-tolylene diisocyanate (2,4-TDI), 2,4′-diphenylmethane diisocyanate (2,4′-MDI), triisocyanatotoluene, isophorone diisocyanate (IPDI), 2-butyl-2-ethylpentamethylene diisocyanate, 2-isocyanatopropylcyclohexyl isocyanate, 3(4)-isocyanatomethyl-1-methylcyclohexyl isocyanate, 1,4-diisocyanato-4-methylpentane, 2,4′-methylenebis(cyclohexyl) diisocyanate, and 4-methylcyclohexane 1,3-diisocyanate (H-TDI), 1,3- and 1,4-phenylene diisocyanate, 1,5-naphthylene diisocyanate, biphenyl diisocyanate, toluidine diisocyanate or 2,6-tolylene diisocyanate.

In addition it is possible, for example, to use oligoisocyanates or polyisocyanates which are preparable from the abovementioned diisocyanates or polyisocyanates or mixtures thereof by linking by means of urethane, allophanate, urea, biuret, uretdione, amide, isocyanurate, carbodiimide, uretonimine, oxadiazinetrione or iminooxadiazinedione structures.

It will be appreciated that mixtures of said isocyanates can also be used.

If it is desired to use at least one core molecule, then it is usual to use an excess of compound of the formula I. Examples of suitable molar excesses of compound of the formula I are from 1:1 to 1 000:1, based in each case on the number of functional groups in the core molecule.

For performing the process of the invention it is preferred to use a catalyst. Enzymes are suitable examples. If it is desired to use enzymes, then the use of lipases and esterases is preferred. Highly suitable lipases and esterases are of Candida cylindracea, Candida lipolytica, Candida rugosa, Candida antarctica, Candida utilis, Chromobacterium viscosum, Geotrichum viscosum, Geotrichum candidum, Mucor javanicus, Mucor miehei, pig pancreas, Pseudomonas spp., Pseudomonas fluorescens, Pseudomonas cepacia, Rhizopus arrhizus, Rhizopus delemar, Rhizopus niveus, Rhizopus oryzae, Aspergillus niger, Penicillium roqLiefortii, Penicillium camembertii or esterase from Bacillus-spp. and Bacillus thermoglucosidasius. Particular preference is given to Candida antarctica lipase B. The enzymes listed are available commercially, from Novozymes Biotech Inc., Denmark, for example.

It is preferred to use enzyme in immobilized form, on silica gel or Lewatit®, for example. Methods of immobilizing enzymes are known per se, from, for example, Kurt Faber, “Biotransformations in organic chemistry”, 3rd edition, 1997, Springer Verlag, section 3.2 “Immobilization” pages 345-356. Immobilized enzymes are available commercially, from Novozymes Biotech Inc., Denmark, for example.

The amount of enzyme used is normally from 1 to 20% by weight, in particular 10-15% by weight, based on the mass of the total compound I employed.

In one embodiment of the present invention nonenzymatic catalysts are used.

It is preferred to operate in the presence of an acidic inorganic, organometallic or organic catalyst or mixtures of two or more acidic inorganic, organometallic or organic catalysts.

Examples of acidic inorganic catalysts for the purposes of the present invention are sulfuric acid, phosphoric acid, phosphonic acid, hypophosphorous acid, aluminum sulfate hydrate, alum, acidic silica gel (pH 5 6, especially ≦5), and acidic alumina. Also suitable for use, for example, are aluminum compounds of the formula Al(OR)₃ and titanates of the formula Ti(OR)₄ as acidic inorganic catalysts, it being possible for each radical R to be the same as or different from the others and selected independently of the others from

C₁-C₁₀ alkyl radicals, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, 2-ethylhexyl, n-nonyl or n-decyl, and

C₃-C₁₂ cycloalkyl radicals, such as cyclopropyl, cyclobutyl, cyclopentyl, cyclohexyl, cycloheptyl, cyclooctyl, cyclononyl, cyclodecyl, cycloundecyl, and cyclododecyl; preferably cyclopentyl, cyclohexyl, and cycloheptyl.

The radicals R in Al(OR)₃ and/or Ti(OR)₄ are preferably each identical and selected from isopropyl and 2-ethylhexyl.

Preferred acidic organometallic catalysts are selected, for example, from dialkyltin oxides R₂SnO in which R is as defined above. One particularly preferred representative of acidic organometallic catalysts is di-n-butyltin oxide, which is available commercially as the product known as oxotin or as Fascat® grades.

Preferred acidic organic catalysts are acidic organic compounds having, for example, phosphate, sulfonic acid,.sulfate or phosphonic acid groups. Particular preference is given to-sulfonic acids such as para-toluenesulfonic acid, for example. Acidic ion exchangers can also be used as acidic organic catalysts, examples being sulfo-functional polystyrene resins crosslinked with about 2 mol % of divinylbenzene.

Combinations of two or more of the aforementioned catalysts can also be employed. A further option is to use those organic or organometallic or else inorganic catalysts that are present in the form of discrete molecules in immobilized form.

Acidic inorganic, organometallic or organic catalyst is used, if desired, in accordance with the invention at from 0.01 to 10% by weight, preferably from 0.02 to 2% by weight.

If it is desired to use enzyme-based catalysts then the process of the invention is performed preferably at temperatures in the range from 0° C. to 120° C., more preferably at temperatures below 100° C., very preferably at temperatures in the range from 40° C. to 80° C., and with particular preference at from 60 to 80° C.

If acidic inorganic, organometallic or organic catalysts are employed then the process of the invention is conducted preferably at temperatures from 80 to 200° C., more preferably from 100 to 180° C., and in particular at up to 150° C. or below.

In one embodiment of the present invention the process of the invention is conducted in the presence of a solvent. Suitable examples include hydrocarbons such as paraffins or aromatics. Particularly suitable paraffins are n-heptane and cyclohexane. Particularly suitable aromatics are toluene, ortho-xylene, meta-xylene, and para-xylene, xylene in the form of an isomer mixture, ethylbenzene, chlorobenzene, and ortho- and meta-dichlorobenzene. The following are also especially suitable: ethers such as dioxane or tetrahydrofuran and ketones such as methyl ethyl ketone and methyl isobutyl ketone, for example.

It is possible, however, to do without the use of solvents if compound I or all of the compounds is or are liquid under reaction conditions. The use of solvent is preferably foregone when compound I is liquid under reaction conditions.

In one embodiment of the present invention the process of the invention is conducted under an inert gas atmosphere, i.e., under carbon dioxide, nitrogen or noble gas, for example, with argon and nitrogen deserving particular mention.

The pressure conditions of the process of the invention are not critical per se. It can be operated at a greatly reduced pressure, at from 0.1 to 500 mbar, for example. The process of the invention can also be conducted at pressures above 500 mbar. For reasons of simplicity it is preferred to carry out reaction at from 500 mbar up to atmospheric pressure, although a slightly elevated pressure regime, up to 1 200 mbar for example, is also possible. Operation can be carried out under greatly increased pressure, at pressures up to 10 bar, for example. Reacting at from 0.1 mbar to atmospheric pressure is preferred.

One embodiment of the present invention operates in the presence of a water remover additive, which can be added at the beginning of the reaction. This embodiment is preferred when the catalyst used comprises one or more enzymes. Examples of suitable such additives are low-acidity silica gels, low-acidity aluminas, molecular sieves, especially 4 Å molecular sieve, MgSO₄, and Na₂SO₄. In the course of the reaction it is possible to add further water remover or to replace existing water remover by fresh water remover.

One embodiment of the present invention operates with a water separator and azeotrope former in order to separate off water or alcohol or carboxylic acid formed during the reaction.

The reaction time may amount to a figure usually in the range from 2 to 48 hours, with from 8 to 36 hours being preferred.

The hyperbranched polymers prepared by the process of the invention can be worked up using standard operations. The catalyst can be separated off, by filtration or other standard laboratory methods, for example. If a solvent has been used, it is usual to concentrate-the reaction mixture, generally under reduced pressure. Other suitable workup methods are precipitation following the addition of suitable agents, water for example, and subsequent washing and drying.

Compounds of the formulae I and Ia are known per se. Compounds of the formula I, for example, can be obtained by reacting compounds of the formula II with olefins of the formula IIIa and IIIb in a Michael addition.

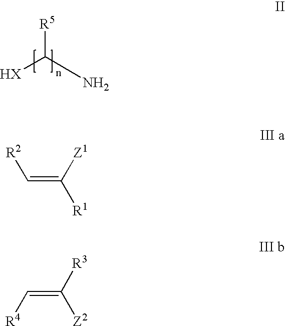

Where the radical pairs R¹ and R³, R² and R⁴, and Z¹ and Z² are each identical in compounds of the formula I, and where n and the corresponding radicals R⁵ are each identical, then compounds of the formula I are prepared by reacting compound of the formula II with two equivalents of IIIa.

Compounds of the formula I a can be prepared by reacting compounds of the formula II with one equivalent of olefin of the formula IIIa.

Mixtures of compounds of the formulae I and Ia are particularly easy to prepare when the radical pairings R¹ and R³, R² and R⁴, and Z¹ and Z² are each identical and n and the corresponding radicals R⁵ are each identical. In that case it is possible to react compound II with about 1.1 equivalents of olefin IIIa and to use the mixture obtained without further workup for the process of the invention.

The present invention further provides hyperbranched polymers obtainable by the process of the invention.

The hyperbranched polymers of the invention have a molecular weight M_{w} of from 500 to 100 000 g/mol, preferably from 3 000 to 20 000 g/mol, more preferably from 3 000 to 7 000 g/mol, and very preferably 4 000 g/mol. The polydispersity Pd is from 1.2 to 50, preferably from 1.4 to 40, more preferably from 1.5 to 30, and very preferably up to 10. Their solubility is usually very good; that is, clear solutions containing up to 50% by weight, in certain cases even up to 80% by weight, of the polymers of the. invention can be prepared in tetrahydrofuran (THF), n-butyl acetate, ethanol, and numerous other solvents without gel particles being visible to the naked eye.

The hyperbranched polymers of the invention are generally carboxyl-terminated, in which case the carboxyl groups may be in esterified form, and can be used with advantage to prepare, for example, adhesives, coatings, foams, coverings, printing inks, and varnishes.

The present invention further provides a process for hydrophilic modification of the hyperbranched polymers of the invention and also provides hydrophilically modified hyperbranched polymers of the invention. To prepare hydrophilically modified polymers of the invention it is possible to start from hyperbranched polymers of the invention and to react them with a hydrophilic compound: for example, with at least one polyhydric alcohol or with at least one alkanolamine.

Examples that may be mentioned of polyhydric alcohols used with preference include the following: alcohols having at least 2 hydroxyl groups, such as ethylene glycol, 1,2-propanediol, 1,4-butanediol, 1,3-propanediol, 1,2-butanediol, glycerol, butane-1,2,4-triol, n-pentane-1,2,5-triol, n-pentane-1,3,5-triol, n-hexane-1,2,6-triol, n-hexane-1,2,5-triol, n-hexane-1,3,6-triol, trimethylolbutane, trimethylolpropane or ditrimethylolpropane, trimethylolethane, pentaerythritol or dipentaerythritol; sugar alcohols such as mesoerythritol, threitol, sorbitol, mannitol or mixtures of the aforementioned alcohols. A preferred possibility is to use glycerol, trimethylolpropane, trimethylolethane and/or pentaerythritol.

Examples that may be mentioned of alkanolamines used with preference include the following: monoalkanolamines, N,N-dialkylalkanolamines, N-alkylalkanolamines, dialkanolamines, N-alkylalkanolamines, and trialkanolamines, each having 2 to 18 carbon atoms in the hydroxyalkyl radical and, where appropriate, 1 to 6 carbon atoms in the alkyl radical, preferably 2 to 6 carbon atoms in the alkanol radical and, where appropriate, 1 or 2 carbon atoms in the alkyl radical. Particular preference is given to ethanolamine, diethanolamine, triethanolamine, methyidiethanolamine, n-butyldiethanolamine, N,N-dimethylethanolamine, and 2-amino-2-methylpropan-1-ol. Very particular preference is given to ammonia and N,N-dimethylethanolamine.

The present invention further provides a process for preparing hydrophobically modified hyperbranched polymers using the hyperbranched polymers of the invention, and also provides hydrophobically modified hyperbranched polymers prepared by inventive hydrophobic modification of hyperbranched polymers of the invention.

The preparation of hydrophobically modified hyperbranched polymers of the invention starts, for example, from hyperbranched polymers of the invention and reacts them with at least one hydrophobic alcohol. Examples of alcohols considered hydrophobic include fatty alcohols, meaning for the purposes of the present invention alcohols containing saturated or unsaturated C₁₀-C₄₀ alcohol radicals, or glycerol esterified with one or two equivalents of identical or different fatty acids: for example, with oleic acid, linoleic acid, linolenic acid, myristic acid, palmitic acid or ricinoleic acid. A preferred example is glyceryl monostearate.

The present invention additionally provides hyperbranched polymers modified with at least one ethylenically unsaturated compound, and a process for modifying the hyperbranched polymers of,the invention with an ethylenically unsaturated compound.

The preparation of hyperbranched polymers of the invention modified with at least one ethylenically unsaturated compound starts, for example, from at least one hyperbranched polymer of the invention and reacts it with at least one alcohol or amine in turn comprising at least one ethylenic double bond. Examples of alcohols which in their turn contain at least one ethylenic double bond are 2-hydroxyethyl (meth)acrylate, 3-hydroxypropyl (meth)acrylate, ω-hydroxy-n-butyl (meth)acrylate, and further diols and polyols esterified with (meth)acrylic acid and containing at least one unesterified hydroxyl group. By way of example the following may be mentioned: trimethylolpropane monoacrylate, trimethylolpropane diacrylate, pentaerythrityl tri(meth)acrylate, pentaerythritol triallyl ether, pentaerythrityl di(meth)acrylate monostearate. Also suitable are unsaturated ethers of diols and polyols which contain at least one unetherified hydroxyl group, examples being trimethylolpropane diallyl ether, trimethylolpropane monoallyl ether, and 1,6-hexanediol monovinyl ether. Mention may further be made of unsaturated alcohols such as, for example, hex-1 -ene-3-ol and hex-2-ene-1-ol.

Examples that may be mentioned of suitable amines include allylamine and hex-1-ene-3-amine.

Hyperbranched polymers of the invention modified with at least one ethylenically unsaturated compound are particularly suitable for preparing print varnishes.

The present invention further provides for the use of the hyperbranched polymers of the invention for preparing products of polyaddition or polycondensation, examples being polycarbonates, polyurethanes, and polyethers. The hydroxyl-terminated hyperbranched polymers of the invention are preferably used for preparing polyaddition or polycondensation products such as polycarbonates or polyurethanes.

The present invention provides, furthermore, for the use of the hyperbranched polymers of the invention and of the polyaddition or polycondensation products prepared from the hyperbranched polymers of the invention as a component of adhesives, coatings, foams, coverings, and varnishes. The present invention additionally provides adhesives, coatings, foams, coverings, and varnishes comprising the hyperbranched polymers of the invention. They are distinguished by outstanding performance properties.

The invention further provides with preference printing inks, especially packaging inks for flexographic and/or gravure printing, which comprise at least one solvent or a mixture of different solvents, at least one colorant, at least one polymeric binder, and, optionally, further additives, with at least one of the polymeric binders being a hyperbranched polymer of the invention.

Within the scope of the present invention, hyperbranched polymers of the invention can be used as a mixture with other binders. Examples of other binders for printing inks of the invention comprise polyvinylbutyral, nitrocellulose, polyamides, polyacrylates, or polyacrylate copolymers. A combination which has been found particularly advantageous is that of at least one hyperbranched polymer of the invention with nitrocellulose. The total amount of all binders in the printing ink of the invention is normally 5-35% by weight, preferably 6-30% by weight, and more preferably 10-25% by weight, based on the sum of all the ingredients. The ratio of hyperbranched polymers of the invention to the total amount of all binders is usually in the range from 30% by weight to 100% by weight, preferably at least 40% by weight, although the amount of hyperbranched polymer should generally not be below 3% by weight, preferably 4% by weight, and more preferably 5% by weight, relative to the sum of all ingredients of the printing ink.

Either a single solvent or a mixture of two or more solvents can be used. Solvents suitable in principle are the customary solvents for printing inks, especially packaging inks. Particularly suitable solvents for the printing ink of the invention are alcohols such as, for example, ethanol, 1-propanol, 2-propanol, ethylene glycol, propylene glycol, diethylene glycol, and substituted alcohols such as ethoxypropanol, and esters such as ethyl acetate, isopropyl acetate, n-propyl acetate or n-butyl acetate, for example. A further solvent suitable in principle is water. A particularly preferred solvent is ethanol or a mixture consisting predominantly of ethanol. Among the solvents which are possible in principle, the skilled worker will make a suitable selection in accordance with the solubility properties of the polymer and with the desired properties of the printing ink. It is usual to use from 40 to 80% by weight of solvent in relation to the sum of all ingredients of the printing ink.

Colorants which can be used are customary dyes and, in particular, customary pigments. Examples are inorganic pigments such as titanium dioxide pigments or iron oxide pigments, interference pigments, carbon blacks, metal powders such as aluminum in particular, brass, or copper powder, and also organic pigments such as azo, phthalocyanine or isoindoline pigments. As will be appreciated, it is also possible to use mixtures of different dyes or colorants and also soluble organic dyes. It is usual to use from 5 to 25% by weight of colorant, relative to the sum of all the ingredients.

Printing inks of the invention, and especially packaging inks of the invention, may optionally comprise further additives and auxiliaries. Examples of additives and auxiliaries are fillers such as calcium carbonate, aluminum oxide hydrate or aluminum silicate or magnesium silicate. Waxes increase the abrasion resistance and serve to enhance the lubricity. Particular examples are polyethylene waxes, including oxidized polyethylene waxes having a M_{w} in the range from 1 500 to 20 000 g/mol, petroleum waxes or ceresine waxes. Fatty acid amides may be used to raise the surface smoothness. Plasticizers increase the elasticity of the dried film. Examples are phthalates such as dibutyl phthalate, diisobutyl phthalate, and dioctyl phthalate, citrates or esters of adipic acid. Dispersing assistants can be used to disperse the pigments. In the case of the printing ink of the invention it is possible with advantage to do without adhesion promoters, although this is not intended to indicate that the use of adhesion promoters should be ruled out absolutely. The total amount of all additives and auxiliaries normally does not exceed 20% by weight, relative to the sum of all of the ingredients of the printing ink, and is preferably 0-10% by weight.

The preparation of packaging inks of the invention can be carried out in a way known in principle, by intensive mixing and/or dispersing of the ingredients in customary apparatus, such as one or more dissolvers, one or more stirred ball mills or one or more triple-roll mills, for example. It is advantageous first to prepare a concentrated pigment dispersion with a fraction of the components and a fraction of the solvent, and then to process this dispersion further to the finished printing ink with hyperbranched polymer of the invention, any additional ingredients, and further solvent.

The present invention further preferentially provides print varnishes which comprise at least one solvent or a mixture of different solvents, at least one polymeric binder, and, optionally, further additives, at least one of the polymeric binders being a hyperbranched polymer of the invention, and additionally provides for the use of the print varnishes of the invention for priming, as a protective varnish, and for producing multilayer materials.

Print varnishes of the invention comprise no colorants, but apart from that have the same ingredients as the printing inks of the invention described above. The amounts of the other components increase accordingly.

It has been found that through the use of printing inks of the invention, especially packaging inks, and print varnishes of the invention, with binders based on hyperbranched polymers, it is possible to obtain multilayer materials which feature excellent adhesion between the individual layers. There is no need to add adhesion promoters. In many cases, better results can be obtained without the use of adhesion promoter than if adhesion promoters are added. On polar films in particular it has been possible to bring about a distinct improvement in adhesion.

### SYNTHESIS EXAMPLES

### 1. Preparation of Hyperbranched Polymer 1

A four-neck flask equipped with a stirrer and nitrogen inlet tube was charged under nitrogen and at room temperature with 33.4 g (0.55 mol) of ethanolamine and, dropwise, with 141 g (1.1 mol) of tert-butyl acrylate. After the end of the addition the mixture was stirred at room temperature until the Michael addition was at an end (checked by thin layer chromatography), which was the case after about 2 hours. This gave N,N-di(tert-butylpropionato)aminoethan-2-ol (I.1).

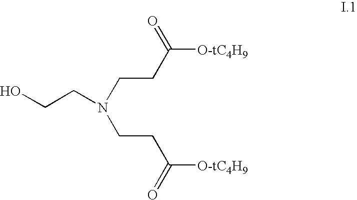

0.17 g (1 000 ppm) of di-n-butyltin oxide, available commercially as Fascat® 4201 (E-Coat, ELF-Atochem), was added and the batch was heated to 130° C. A pressure of 200 mbar was applied in order to separate off the tert-butanol formed during the reaction. After 10 hours the pressure was reduced to 50 mbar and then further to 0.1 mbar. After 15 hours the product was cooled to room temperature. This gave a viscous, oily resin.

Molar mass determination (GPC): Mₙ 4 800 g/mol; M_{w} 7 600 g/mol. Column: stationary phase: polystyrene-hexafluoroisopropanl gel. Mobile phase: 0.05% by weight potassium trifluoroacetate in hexafluoroisopropanol; standard: polymethyl methacrylate.

### 2. Preparation of Hyperbranched Polymer 2

A four-neck flask equipped with a stirrer and nitrogen inlet tube was charged under nitrogen and at room temperature with 50 g (0.82 mol) of ethanolamine and, dropwise, with 141 9 (1.6 mol) of methyl acrylate. After the end of the addition the mixture was stirred at room temperature until the Michael addition was at an end (checked by thin * layer chromatography), which was the case after about 2 hours. This gave N,N-di(methylpropionato)aminoethan-2-ol (1.2).

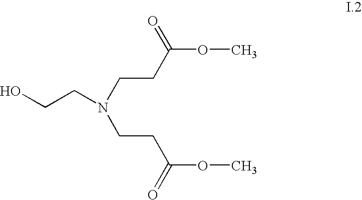

0.19 g (1 000 ppm) of di-n-butyltin oxide, available commercially as Fascat® 4201 (E-Coat, ELF Atochem), was added and the batch was then heated to 130° C. A pressure of 200 mbar was applied in order to separate off the methanol formed during the reaction. After 10 hours the pressure was reduced to 50 mbar and then further to 0.1 mbar.

After 4 hours the product was cooled to room temperature. This gave a viscous, oily, pale yellow resin.

Molar mass determination (GPC): Mₙ 3 700 g/mol; M_{w} 6 000 g/mol. Conditions: as in Example 1.

### 3. Preparation of Hyperbranched Polymer 3

A four-neck flask equipped with a stirrer and nitrogen inlet tube was charged under nitrogen and at room temperature with 33.4 g (0.55 mol) of ethanolamine and, dropwise, with 141 g (1.1 mol) of tert-butyl acrylate. After the end of the addition the mixture was stirred at room temperature until the Michael addition was at an end (checked by thin layer chromatography), which was the case after about 2 hours. This gave N,N-di(tert-butylpropionato)aminoethan-2-ol (I.1).

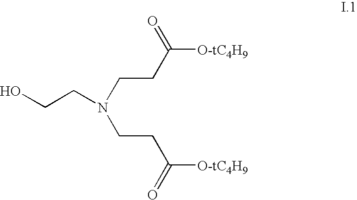

0.17 g (1 000 ppm) of di-n-butyltin oxide, available commercially as Fascat® 4201 (E-Coat, ELF Atochem), was added and the batch was heated to 130° C. A pressure of 200 mbar was applied in order to separate off the tert-butanol formed during the reaction. After 10 hours the pressure was reduced to 50 mbar and then further to 0.1 mbar and the temperature was held at 130° C.

After 210 minutes the batch was cooled to room temperature and a pressure of 1 bar was set using nitrogen. Then 33.4 9 (0.55 mol) of ethanolamine were added. The reaction mixture was subsequently heated at 140° C. for half an hour. Thereafter the pressure was reduced to 25 mbar and the mixture was heated at 140° C. and 25 mbar for one hour more in order to distill off tert-butanol.

After 5 hours the batch was cooled to room temperature and a pressure of 1 bar was set using nitrogen. This gave a viscous, oily resin which was readily soluble in water.

Application examples: preparation of printing inks

Flexographic printing inks F1.1 and F1.2 were prepared by intensively mixing the following components:

| | |
|---|---|
| 70.0 g | blue pigment preparation based on Pigment Blue 15:4 (BASF |
| | Drucksysteme GmbH) |
| 6.0 g | hyperbranched polymer 1 (only for flexographic ink F1.1) |
| 6.0 g | hyperbranched polymer 2 (only for flexographic ink F1.2) |
| 8.0 g | nitrocellulose (Wolf) |
| 1.0 g | oleamide (Croda) |
| 0.5 g | polyethylene wax with an M_{w} of 3 500 g (BASF |
| | Aktiengesellschaft), prepared by polymerizing ethylene at |
| | 1 700 bar and 210° C. in a high-pressure autoclave, |
| | as described by M. Buback et al., Chem. Ing. Tech. |
| | 1994, 66, 510; |
| 10.5 g | ethanol |
| 2.0 g | adhesion promoter Ti(acac)₃; acac: acetylacetonate |

In a second series, flexographic inks F 2.1 and F 2.2 were prepared by intensively mixing the following components:

| | |
|---|---|
| 70.0 g | blue pigment preparation based on Pigment Blue 15:3 (BASF |
| | Drucksysteme GmbH) |
| 6.0 g | hyperbranched polymer 1 (only for flexographic ink F2.1) |
| 6.0 g | hyperbranched polymer 2 (only for flexographic ink F2.2) |
| 8.0 g | nitrocellulose (Wolf) |
| 1.0 g | oleamide (Croda) |
| 0.5 g | polyethylene wax with an M_{w} of 3 500 g (BASF |
| | Aktiengesellschaft), prepared by polymerizing ethylene at |
| | 1 700 bar and 210° C. in a high-pressure autoclave, as |
| | described by M. Buback et al., Chem. Ing. Tech. |
| | 1994, 66, 510; |
| 10.5 g | ethanol |

For purposes of comparison, flexographic printing inks were additionally prepared with conventional polyurethane binders (PUR 7313 (BASF)). Table 1 summarizes the formulations:

TABLE 1
Composition of the printing inks tested

| No. | Binder | Adhesion promoter |
|---|---|---|
| Flexographic ink 1.1 | Hyperbranched polymer 1 | Ti(acac)₃ |
| Flexographic ink 2.1 | Hyperbranched polymer 1 | — |
| Flexographic ink 1.2 | Hyperbranched polymer 2 | Ti(acac)₃ |
| Flexographic ink 2.2 | Hyperbranched polymer 2 | — |
| Flexographic ink C4 | PUR 7313 (BASF | Ti(acac)₃ |
| | Drucksysteme GmbH) | |
| Flexographic ink C5 | PUR 7313 (BASF | — |
| | Drucksysteme GmbH) | |

Substrate Adhesion

The adhesion of the flexographic inks of the invention was measured on polar films of polyamide and PET and also on an apolar film of polypropylene.

Measurement Method:

The “Tesa strength” test method is used to determine the adhesion of a film of printing ink on the print substrate.

Test Procedure

The ink, diluted to printing viscosity, was printed onto the respective film or applied using a 6 μm doctor blade. A strip of Tesa tape (adhesive tape with a width of 19 mm, product BDF 4104 from Beiersdorf AG) was adhered to the film of printing ink, pressed on uniformly, and removed again after 10 seconds. This procedure was carried out four times on the same site on the test specimen but in each case with new tape strips. Each tape strip was adhered in succession to white paper or, in the case of white inks, to black paper. Testing was carried out immediately after application of the flexographic ink.

Evaluation

A visual examination of the surface of the printed film was carried out for damage. The result was rated from 1 (very poor) to 5 (very good). Tables 2 and 3 summarize the results of the tests.

TABLE 2
Test results with flexographic inks comprising adhesion promoter

| | Polypropylene | | |
|---|---|---|---|
| | film | PET film | Polyamide film |
| | (MB 400) | (Melinex 800) | (Walomid XXL) |
| Flexographic ink | 5 | 5 | 2 |
| 1.1 | | | |
| Flexographic ink | 5 | 4 | 2 |
| 1.2 | | | |
| Flexographic ink C4 | 5 | 3 | 1 |

TABLE 3
Test results with printing inks comprising no adhesion promoter

| | Polypropylene | | |
|---|---|---|---|
| | film | PET film | Polyamide film |
| | (MB 400) | (Melinex 800) | (Walomid XXL) |
| Flexographic ink | 5 | 5 | 2 |
| 2.1 | | | |
| Flexographic ink | 5 | 5 | 2 |
| 2.2 | | | |
| Flexographic ink C5 | 1 | 1 | 1 |

Production of Composite Materials

Printing inks 1.1 to C5 were used to produce multilayer materials with different films. The quality of the composites is determined by measuring the adhesion between two films joined by lamination.

### APPLICATION EXAMPLES 4-9

General Procedure

The flexographic ink, diluted to printing viscosity, was pressed onto film 1 as print substrate. In parallel with this, the laminating film (film 2) was coated with an adhesive/hardener mixture (R&H MOR-FREE A 4123/ Hardener C88) so as to give a film thickness of approximately 6 μm. The two films were subsequently pressed together so that the printing ink and the adhesive came into contact. After being pressed together, the composite films obtainable in this way were stored at 60° C. for 3 days, after which the composite adhesion was measured. The results of the tests are summarized in Table 4.

Test Method:

Measuring and testing apparatus: tensile strength tester from Zwick
Punch (width: 15 mm)

At least 2 strips (width: 15 mm) of each test composite material were cut, lengthwise and transversely with respect to the film web. In order to facilitate separation (delamination) of the composite the ends of the punched strips were immersed in a suitable solvent (e.g., 2-butanone) until the materials underwent detachment from one another. Thereafter the specimen was carefully dried. The delaminated ends of the test specimens were clamped into the tensile strength tester. The less stretchy film was inserted into the upper clamp. When the machine was started, the end of the specimen was held at right angles to the direction of tension, ensuring a constant tension. The take-off speed was 100 mm/min, the take-off angle of the separated films in relation to the unseparated complex 90°.

Evaluation:

The composite adhesion was read off as an average value, reported in N/15 mm.

TABLE 4
Results for the composite films

| | | | | | Composite |
|---|---|---|---|---|---|
| | Film 1 | Film 2 | | | adhesion |
| | print | laminating | Flexographic | Adhesion | [N/ |
| Example | substrate | film | ink | promoter | 15 mm] |
| 4 | polyamide | PE | 1.1 | Ti(acac)₃ | 6.3 |
| 5 | polyamide | PE | 2.1 | — | 5.2 |
| 6 | PET | PE | 1.1 | Ti(acac)₃ | 4.3 |
| 7 | PET | PE | 2.1 | — | 4.1 |
| 8 | PP | PE | 1.1 | Ti(acac)₃ | 3.2 |
| 9 | PP | PE | 2.1 | — | 3.9 |

Polyamide film: Walomid XXL,
PET film: Melinex 800,
PP film: MB 400.

The test results show that the adhesion of the flexographic inks of the invention can be distinctly improved even on chemically different types of film through the use of the hyperbranched polyester amines, in comparison to conventional binders. There is no need for adhesion promoters, and despite this very good results are achieved.

Composite films of the invention produced using flexographic inks comprising hyperbranched polyester amines exhibit outstanding adhesion, especially when polar films are used. This result is all the more surprising given the fact that it was not suggested by the tests with adhesive tape strips.

1. A process for preparing hyperbranched polymers comprising reacting compounds of the formula I 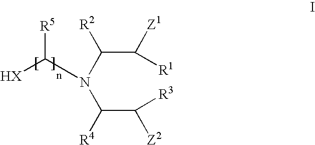
where
X is sulfur or oxygen,
R¹ and R³ are identical or different and are hydrogen, C₁-C₆ alkyl, C₃-C₁₂ cycloalkyl or C₆-C₁₄ aryl,
R² and R⁴ are identical or different and are hydrogen, C₁-C₆ alkyl, C₃-C₁₂ cycloalkyl, C₆-C₁₄ aryl,
Z¹ and Z² are identical or different and are COOH or COOR⁶, the radicals R⁶ being identical or different and being C₁-C₆ alkyl, formyl or CO—C₁-C₆ alkyl,
R⁵ identically or differently at each occurrence is C₁-C₆ alkyl or hydrogen, and
n is an integer from 2 to 10,
optionally with at least one compound of the formula Ia 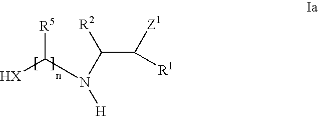
where the variables are as defined above,
in the presence of a catalyst.

2. The process according to claim 1, wherein R¹ and R³ in formula I are identical.

3. The process according to claim 1, wherein R² and R⁴ in formula I are identical.

4. The process according to claim 1, wherein Z¹ and Z² in formula I are each COOH.

5. The process according to claim 1, wherein Z¹ and Z² in formula I are each COOR⁶.

6. The process according to claim 1, wherein the radicals R⁶ in formula I are each identical.

7. The process according to claim 1, wherein R¹ and R³ in formula I are each identical and are methyl or hydrogen, R² and R⁴ in formula I are each hydrogen, and Z¹ and Z² in formula I are each COOR⁶.

8. The process according to claim 1, wherein from 0 to 1 000% by weight of compound of the formula Ia are used, based on compound of the formula I.

9. The process according to claim 1, wherein the reaction is carried out in the presence of at least one polyfunctional compound.

10. The process according to claim 1, wherein the reaction is carried out in the presence of at least one enzyme.

11. The process according to claim 1, wherein the reaction is carried out in the presence of an acidic inorganic, organometallic or organic catalyst or a mixture of two or more acidic inorganic, organometallic or organic catalysts.

12. A hyperbranched polymer obtained by the process according to claim 1.

13. A process for preparing hydrophilically modified hyperbranched polymers, comprising reacting the hyperbranched polymer according to claim 12 with a hydrophilic compound.

14. A hydrophilically modified hyperbranched polymer obtained by the process according to claim 13.

15. A process for preparing hydrophobically modified hyperbranched polymers, comprising reacting the hyperbranched polymer according to claim 12 with at least one hydrophobic alcohol.

16. A hydrophobically modified hyperbranched polymer obtained by the process according to claim 15.

17. A process for preparing hyperbranched polymers modified with at least one ethylenically unsaturated compound, comprising reacting the hyperbranched polymer according to claim 12 with at least one alcohol or amine which has an ethylenically unsaturated double bond.

18. A hyperbranched polymer modified with at least one ethylenically unsaturated compound, obtained by the process according to claim 17.

19. A method for producing a formulation wherein said formulation is an adhesive, a coating, a foam, a covering, a printing ink or a varnish, comprising adding the hyperbranched polymer according to claim 12 to said formulation.

20. A printing ink prepared by utilizing the hyperbranched polymer according to claim 12 in a printing ink formulation.

21. A print varnish prepared by utilizing the hyperbranched polymer according to claim 12 in a print varnish formulation.

22. A print varnish prepared by utilizing the hyperbranched polymer modified with at least one ethylenically unsaturated compound according to claim 17 in a print varnish formulation.
